(19) United States
(12) Patent Application Publication
(10) Pub. No.: US 2008/0052159 A1
(43) Pub. Date: Feb. 28, 2008

(54) Service promotion using encodable review codes

(76) Inventors: Venkataraman Balakrishnan, Houston, TX (US); Kannan Balakrishnan, Mountain View, CA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 11/728,802

(22) Filed: Mar. 26, 2007

Related U.S. Application Data
(60) Provisional application No. 60/743,785, filed on Mar. 26, 2006.

(51) Int. Cl. G06Q 30/00; G07G 1/00

(52) U.S. Cl. 705/14; 705/10

(57) ABSTRACT

According to certain embodiments, at least one encodable review code associated with providing services to a consumer is provided for use as a consumer interface to interact with the consumer, wherein the encodable review code is encoded based on a review code type.

### CROSS REFERENCE TO RELATED APPLICATIONS

This application claims the benefit of U.S. Provisional Patent Application No. 60/743,785 filed Mar. 26, 2006, entitled, “System, Method and Computer Program Product To Collect Feedback From Consumers Instantly At The Point Of Service And Promote The Services By Consumers Using Wireless Communication Devices,” by Venkataraman Balakrishnan, and which is hereby incorporated by reference in its entirety.

### FIELD OF THE INVENTION

The present invention is related to electronic transactions between service and/or product merchants and consumers.

### BACKGROUND OF THE INVENTION

Providers of products and services depend on word of mouth feedback from their customers to understand and improve the quality of their service and/or products. However, there is no convenient way to document such word of mouth feedback. Similarly, consumers who purchasers of products and services find it difficult to keep track products and services they liked and the ones that they did not.

### BRIEF DESCRIPTION OF THE DRAWINGS

FIG. 1 is a block diagram that illustrates high level interaction of some components of a system for interacting with consumers of products and services, according to certain embodiments of the invention.

FIG. 2 is a block diagram that illustrates the registration services for registering providers and consumers in a system for interacting with consumers of products and services, according to certain embodiments of the invention.

FIG. 3 is a block diagram that illustrates aspects of a review code manager, according to certain embodiments of the invention.

FIG. 4 is a block diagram that illustrates aspects of a process by which a consumer uses a review code in an electronic transaction, according to certain embodiments of the invention.

FIG. 5 is a block diagram that illustrates aspects of a review client, according to certain embodiments of the invention

FIG. 6 is a block diagram that illustrates aspects of a review server, according to certain embodiments of the invention.

FIG. 7 is a block diagram that illustrates aspects of procedures by which a consumer can receive and manage promotional coupons, take part in promotional raffles and/or polls, according to certain embodiments of the invention.

FIG. 8 is a block diagram that illustrates aspects of procedures for product registration and service call initiation, according to certain embodiments of the invention.

### DETAILED DESCRIPTION

Methods, systems, user interfaces, and other aspects of the invention are described. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention. The specification and drawings are, accordingly, to be regarded in an illustrative rather than a restrictive sense.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well known to those of ordinary skill in the art are not described in detail to avoid obscuring aspects of the present invention.

According to certain embodiments, at least one encodable review code associated with providing services to a consumer is provided for use as a consumer interface to interact with the consumer, wherein the encodable review code is encoded based on a review code type. According to certain aspects, the encoding either is performed dynamically by a service or product provider that interacts with a review system or is pre-determined.

According to certain embodiments, the,review systems is configured to 1) update a review database associated with the review code, 2) determine awards associated with the encoded review code, 3) update recommendation data associated with the review code, 4) manage service queues associated with the encoded review code, 5) process registration in a raffle, 6) manage coupons, and 7) manage a poll or survey, 8) manage service calls, and 9) process registration of products.

According to certain embodiments, an encoded review code is received at the review server. The received encoded review code is processed by performing at least one of: 1) updating a review database associated with the review code, 2) determining awards associated with the encoded review code, 3) updating recommendation data associated with the review code, 4) managing service queues associated with the encoded review code, 5) processing registration in a raffle, 6) managing coupons, 7) managing a poll or survey, 8) managing service calls, and 9) processing registration of products. According to one aspect, an encoded review code is captured by a client device. The captured encoded review code is sent to the review system for processing.

According to certain embodiments, the use of wireless mobile communication device, equipped with camera in some cases, allows consumers perform service transactions quickly and easily. For example, a consumer can quickly provide feedback on the service the consumer received, at the point of the service. The review system automatically registers the feedback information. The feedback information received from various consumers can be analyzed to provide business intelligence for improving services offered by the respective service and or product provider.

Other non-limiting examples of service transactions include providing a review of a service, product or person, requesting or registering for awards and/or coupons, making recommendations regarding a service, product or person, registering for a service queue, raffle, poll or survey, and causing initiation of service calls.

Information associated with service transactions including service promotions stored in the system can be used by the product/service provider to understand consumer behavior and preferences.

According to one aspect of certain embodiments, the consumer's communication device automatically stores the service transactions and allows the consumer to review them at a later time or pass information associated with the stored service transaction to another consumer by a simple action on the mobile communication device.

Notwithstanding the discrete blocks, components, modules, functions and/or databases shows in the figures described herein, the figures are intended to be a functional descriptions of some embodiments of the invention rather than structural descriptions of functional elements in the embodiments. One of ordinary skill in the art will recognize that an actual implementation might have the functional elements grouped or split among various components.

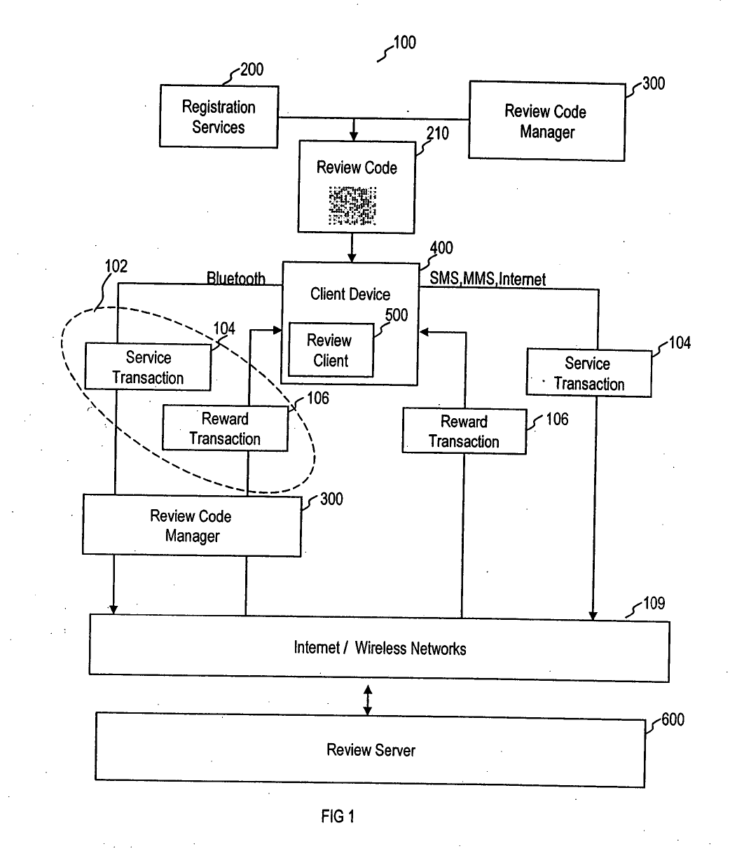

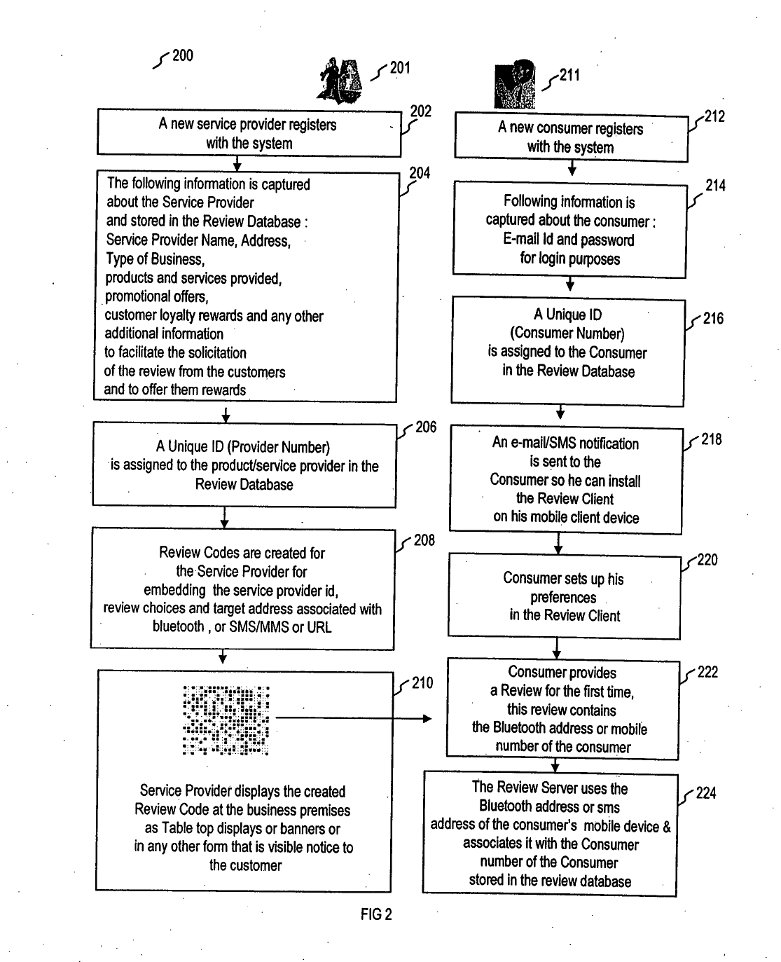

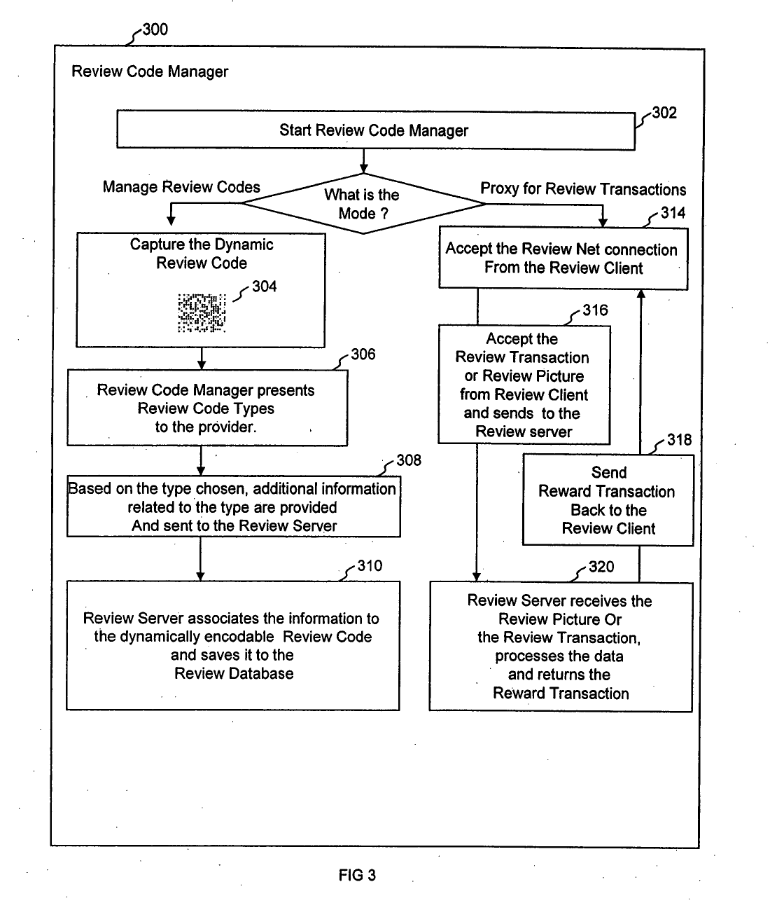

FIG. 1 is a block diagram that illustrates high level interaction of some electronic components of a review system 100 for interacting with consumers of products and services, according to certain embodiments of the invention. FIG. 1 shows a registration services 200, a review code manager 300, a review code 210, a client device 400 with a review client 500, a review net 102, a service transaction 104, a reward transaction 106, network 109 and review server 600. Consumers and product/service providers register with the review system using registration services 200, which is described in greater detail herein with reference to FIG. 2. Review code manager 300, among other functions, helps the provider configure review codes in the case of dynamic encoding of review codes, and can act as proxy for handling service transactions from consumer's review client. Review code manager 300 is described in greater detail herein with reference to FIG. 3.

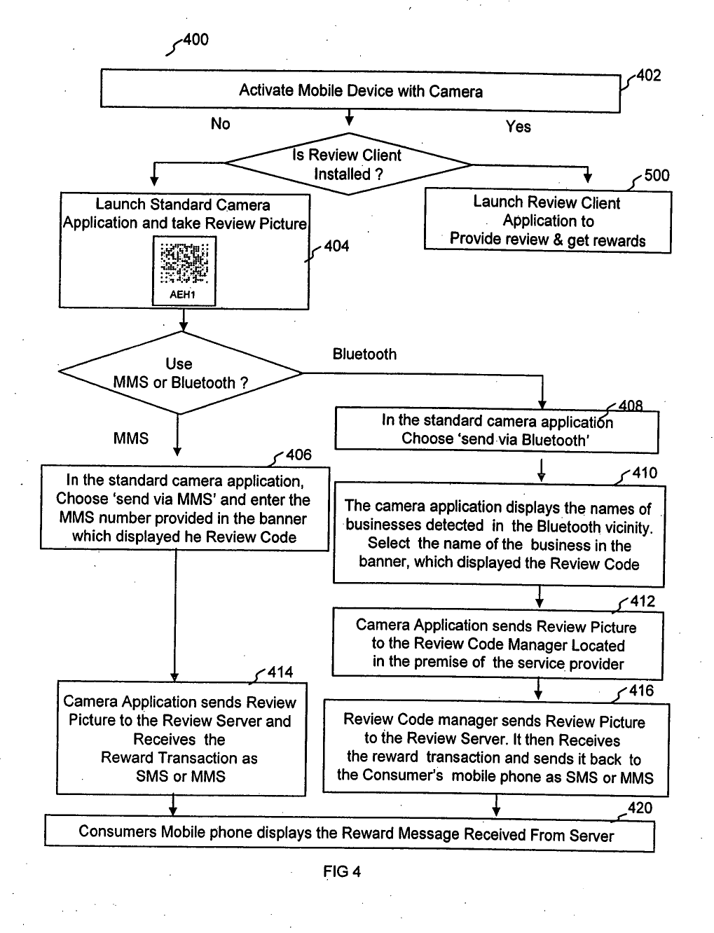

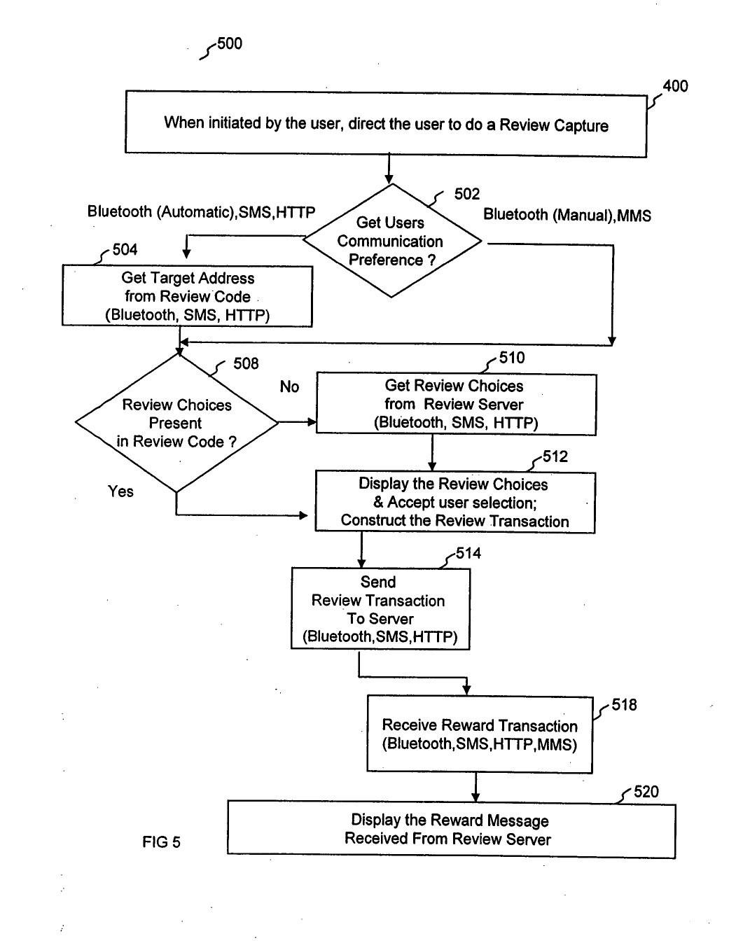

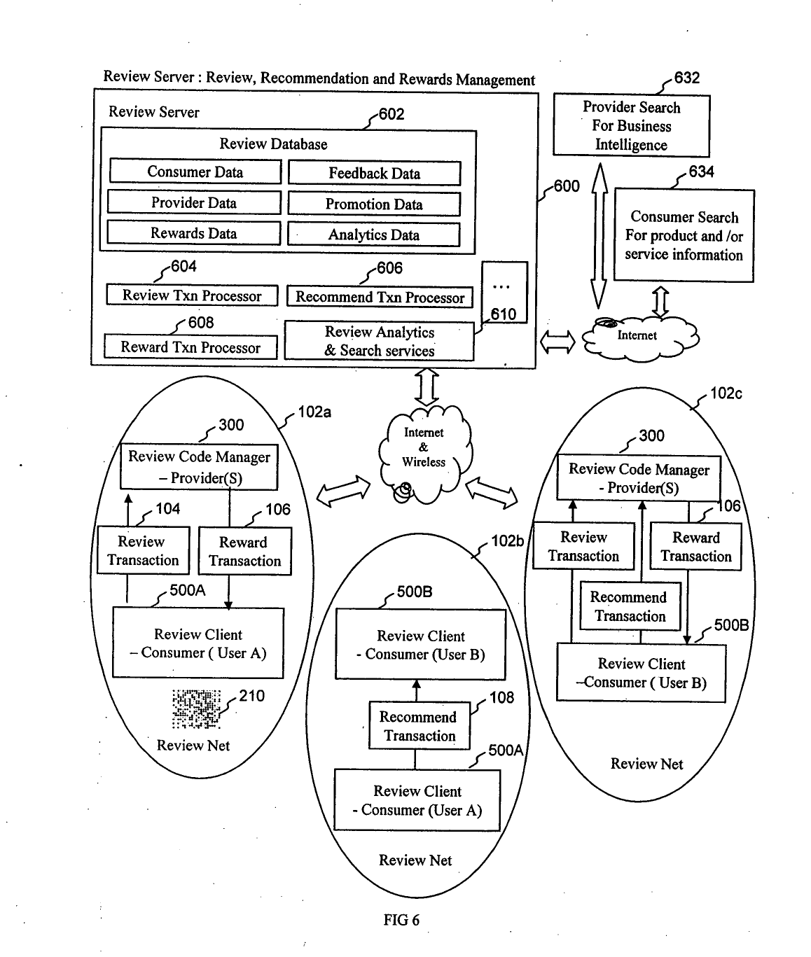

For purposes of explanation, assume that a consumer uses client device 400 to capture review code 210. For example, assume that the client device is equipped with a camera and captures an image of the review code using the camera. Review client 500 can either send the captured review code to review server 600 either by bluetooth through the provider's review net 102, for example, or by direct Internet connection using short message service (SMS) or multimedia media message service (MMS), for example. Client device 400 is described in greater detail herein with reference to FIG. 4. Review client 500 is described in greater detail herein with reference to FIG. 5. Review server 600 is described in greater detail herein with reference to FIG. 6. Further assume, that the consumer is targeted for an award based on frequency of visits to the provider's establishment. For example, the provider may be interested in awarding special rewards to consumers for actions such as first time visit or frequent visits or for recommending the product and service to other consumers. FIG. 1 shows a rewards transaction (106) is returned to the client device.

Review net 102 is a communication link formed instantly between the consumer's client device 400 (for example, a mobile phone), and the provider's mobile phone using a communication channel and the provider number embedded in the captured review code 210, when the consumer captures review code 210.
The following describes the use of a review net, according to certain embodiments:
   The consumer takes a picture of the review code using the camera client device. The review code capture can occur either at the premises of the provider (such as restaurant) or the premises of the consumer (his home, where a plumber is providing plumbing services) or some other place (for example, the consumer has a stalled car at a road side and is being services by a towing service).
   The review client installed at the mobile phone of the consumer decodes the captured review code to determine the provider number that is embedded in the review code.
   The review client uses the provider number as the target address to establish a connection either:
      with provider's mobile device or computing device (using short range wireless, such as Bluetooth or WiFi or Wireless USB communication); or
      with the review server (using long range wireless, such as SMS, MMS, e-mail or http over internet).
Once the review net is formed, the capture image of the review code is transmitted from the consumers mobile device to either
   the review server directly, or
   the provider's mobile phone or device, which then forwards the captured review code to the review server using a long range communication channel
The above process has the following features:
   The use of the provider's number as embedded information within the review code eliminates the need for the consumer to type in an address for the provider.
   The use of the provider's number as embedded information within the review code eliminates any conflicts between multiple devices in the proximity that can potentially receive the review code from the client device. Thus, embedded information within the review code specifically targets the provider's mobile device.
   The use of short range communication between the consumer and provider devices eliminates any communication cost for the consumer. The captured image of the review code is transmitted to the review server using the long range channel (internet connection) is also free to the consumer because it can be paid for by the provider.

FIG. 2 is a block diagram that illustrates the registration services for registering providers and consumers in a system for interacting with consumers of products and services, according to certain embodiments of the invention.

A provider 201 is a person or business entity that offers products or services for a price or free of charge to respective consumer(s). Consumer 211 is a person or business entity who receives products or services from provider 201 and may volunteer to provide feedback or a quick review of the received products/services. A consumer may also be interested in recommending a product or service from a provider to his social network, such as friends and family members.

A person or business entity may be a provider of a product or service to other consumers, and at the same time be a consumer of product and service from other providers. For Example, a restaurant may be a provider of food and services to its customers, but at the same time is a consumer of paper products from another paper product provider.

With reference to FIG. 2, assume that provider 201 seeks feedback from consumer 211, with the objective of improving the products or services. New providers and new consumers register with the review system (202, 212). During the registration, the following is an example of the type of information about the provider that is captured and stored in a review database (204): Service Provider Name, Address, Type of Business (optional), products and services provided (optional), promotional offers (optional), customer loyalty rewards (optional), any other additional information to facilitate the solicitation of the review from the customers and to offer them rewards (optional). Similarly, during registration, the following is an example of the type of information about the consumer that is captured and stored in a review database (214): e-mail id and password for login purposes.

A Unique ID (Provider Number) is assigned to the product/service provider in the review database 206. Review codes are created for the Service Provider for embedding the service provider id, review choices and target address associated with bluetooth, or SMS/MMS or URL (208). Service Provider displays the created review code(s) at the business premises as table top displays or banners, for example, or in any other form that is visible notice to the customer (210). A Unique ID (Consumer Number) is assigned to the consumer in the review database (216). An e-mail/SMS notification is sent to the consumer so he can install the review client on his mobile client device (218). Consumer sets up his preferences in the installed review client (220). Assume that the Consumer provides a review for the first time (222) by capturing a review code displayed by the provider (210). The captured review code now includes the Bluetooth address or mobile number of the consumer. The Review Server uses the Bluetooth address or SMS address of the consumer's mobile device & associates such an address with the consumer number of the consumer stored in the review database (224).

The provider number (206 in FIG. 2) is a unique id provided to a service provider who registers with the system. Every provider in the system will be identified by this unique provider number. A provider may associate one or more mobile numbers or (e-mails id) to his provider number. When a wireless message is received from a mobile phone or device, the Review Server (600 in FIG. 1) will use this association to identify the provider number of this provider. This association will also be used by the Review Server to find the mobile number required to send wireless messages to the provider.

The consumer number is a unique id provided to a consumer who registers with the system. A consumer in the review system is identified by this unique consumer number. A consumer may associate one or more mobile numbers or (one or more e-mail ids) with the consumer number. When a wireless message is received from a mobile number, the Review Server will use the associated customer number to identify the consumer. Further, this association enables the Review Server to find the mobile number of a specific consumer to send any messages to the consumer.

A review code is a special form of bar code, according to certain embodiments. According to certain embodiments, a review code is used to encode a review choice. A review choice is an opinion as represented by the consumer, such as ‘I liked the service provided by provider 123456’ or ‘I did not liked the product offered by provider 123456’. The review choices may be determined for the respective provider, based on the service or products offered and the feedback that the specific provider would like to seek from their consumers. Each review choice is uniquely identified by a Review Choice number, according to certain embodiments.
Unlike traditional barcodes which use specialized laser technology, the review codes may 2D barcodes that can be captured as images even by a low resolution camera, found in most of the mobile phones.
According to certain other embodiments, review codes can also be represented in short range memory device such as an RFID Tags. In such cases, the review client will use an RFID reader to the read the RFID tag for decoding the review choices encoded in the review code.
Review codes may be generated by the review server when a provider registers with the server and offers information such as the nature of the products and service he offers and the type of feedback he seeks from consumers.
Review codes can be printed to paper or displayed electronically in a computer screen or a mobile phone display. The consumer can the simply take a picture of the displayed review code with the camera on his mobile phone, for example. Review codes can also be included in any marketing information published by the provider in mass media such as news papers, magazines and television programs.
Below are examples illustrating the use review codes:
   A trucking company may want to get feedback on the company drivers. Typically, the trucking company displays a phone number at the back of the truck. In order to provide a review, a consumer has to memorize down the license plate number of the truck and call the displayed phone number. In the proposed review system the trucking company may display a Review Code that has embedded in it the license plate number identifying the truck. When a consumer notices bad behavior of the truck in the road way, the consumer simply takes a picture of the Review Code and provide a quick review suing his camera quipped mobile device.
   A Review code can also be used to encode instructions to the review client to construct a employee performance review transaction, a recommend Transaction, an award transaction and/or an a wait Transaction, for example.

The consumer can use the camera in their mobile phones to take a picture (electronic image) of the review code, in order to submit a quick review. For example, the consumer can take a picture of the Review Code which encodes ‘I liked the service provided by service provider number 123456’ and then submit it wirelessly to the Review Server or to the providers mobile phone. By taking a Review picture and sending it to the Review Server or the provider's mobile phone, the consumer voluntarily provides a feedback.

Non-limiting examples of service transactions include review transactions, reward transactions, recommend transactions, performance review transactions, wait transactions,

According to certain embodiments, a review transaction is an electronic representation of the quick review provided by a consumer for a provider. A review transaction includes the following information:
Provider Number
Consumer Number
Review Choice Number
Date and Time of the Review
Review Transaction number.

According to certain embodiments, a reward transaction is an electronic representation of the award to be presented by the provider to the consumer, based on various criteria such as the number of repeat visits, recommendations given by the consumer to others, etc. The Reward Transaction includes the following information:
Provider Number
Consumer Number
Date and Time of award
Award details such as dollar value, % discounts of the current sale.

According to certain embodiments, a recommend transaction is an electronic representation of the quick review provided by one consumer to another consumer, for a provider. A recommend transaction includes the following information:
Provider Number
Consumer Number who recommends the product or service
Consumer Number who receives the recommendation
Date and Time of the Recommendation
Review Transaction number

According to certain embodiments, an employee performance review transaction is special form of a review transaction that associates the review transaction with a particular employee in the provider's organization. For example, a restaurant may have many wait staff (employees) who provide services to the customers. In such cases, the review transaction will also include the Employee Number of the respective wait staff who provided the service. The Employee Performance Review Transaction includes the following information:
Provider Number
Employee Number
Consumer Number
Review Choice Number
Date and Time of the Review
Review Transaction number.

A Wait Transaction is an electronic representation of a consumer waiting to receive a product or service because the provider is running out of capacity to service consumers or provide products due to backlog. A Wait transaction includes the following information:
Provider Number
Consumer Number who is waiting
Date and Time of the Registration for the wait
Wait Transaction number

FIG. 3 is a block diagram that illustrates aspects of a review code manager 300, according to certain embodiments of the invention. The review code manager associated with the provider's review is started (302). If the provider decides to dynamically configure review code, review code manager is used to capture an encodable review code provided by the review system (304). for example, a picture can be taken of the encodable review code. The review code manager presents review code types that can be used for encoding the encodable review code (306). Based on the type chosen, additional information is provided by the provider to the review code manager and the information is sent to the review server (308). The review server associates the information to the dynamically encodable review code and saves the information to the review database (310). If the review code manager is acting as a proxy for review transactions received from a consumer, then the review net connection from the consumer's client device is accepted (314). The imaged review code or other representation of the review transaction is accepted form the consumer's client device (316). The review server receives the imaged review code or other representation of the review transaction, processes the associated data and returns a reward transaction, assuming that the consumer is eligible for award (320). The reward transaction is sent to eth consumer's review client on the consumer's client device (318) through the review net connection.

The dynamically encodable review code (304 in FIG. 3) is another form of a Review Code, which only contains a unique number called Review Code Number. The dynamic review code is associated to the information it represents by the following process:
The Provider uses the Review Code Manager in his mobile phone to take a picture of the Review Code and extract the Review Code Number.
The Review Code Manager uses the natural interface in the mobile phone to associate the Review Code with information such as
   Provider Number
   Employee Number
   Review Code Type
      Standard Review Code type
      Employee Performance Review Code type
      Wait Transaction type
Once the association is made by the Provider, the review code is sent to the Review Server and stored in the review database.

When a consumer takes a picture of this dynamically encoded Review Code, the Review Client sends the Review Code Number and obtains the associated details from the server, as described in greater detail herein with reference to FIG. 5.

A dynamically encodable Review Code used in this manner can be re-used multiple times, each time to associate with a different review transaction.

The above method of dynamically defining/encoding Review Codes allows the generation of Review Codes independent of the target function of the Review Code as determined by the provider and decreases the cost of producing and operating the review codes.

Following are examples of how dynamic review code can be used:
A movie theater may want to collect reviews of movies that it screens. As a provider, the movie theater operator displays a dynamically encoded review code at the exit gates where each movie is shown. Whenever a new movie is being screened at a particular room, the provider uses the Review Code Manager to associate the dynamically encoded review code displayed at the respective gate with the movie that is being screened at that room.
Consumers, after watching the movie, can capture the Review Code displayed at the exit gate, in order to provide a quick review.

FIG. 4 is a block diagram that illustrates aspects of a process 400 by which a consumer uses a review code in a service transaction, according to certain embodiments of the invention. FIG. 4 shows the process starting by activating a mobile device with a camera (402) of the consumer. If a review client is already installed, then the installed review client. Aspects of using the review client for performing service transactions is described in greater detail herein with reference to FIG. 5.

If a review client is not already installed at the consumer's mobile device, the standard camera application at the mobile device is launched to take a picture of the review code representing the desired service transaction that the consumer wishes to perform (404). If the consumer decides to use a Bluetooth connection rather than SMS or MMS or other direct Internet connection, then the “send via Bluetooth’ is selected (408). The camera application displays the names of the business detected in the Bluetooth vicinity, The consumer can select the name of the business associated with the review code (410). The image of the review code is sent to the review code manager associated with the provider (412). The review code manager sends the review code to the review server. The review server returns a rewards transaction to eth consumer's mobile device if the consumer is eligible for an award (416). The consumer's mobile device displays the rewards message received (420). If an MMS or connection is used, for example, then the “send via MMS’ is selected and the MMS number displayed with the review code is entered (406). The camera application sends the review code image to the review server and receives the reward transaction as an MMS (414). The consumer's mobile device displays the rewards message received (420).

In one embodiment where the consumer has not installed the Review Client in his mobile device the consumer can still provide a review by just taking a review picture and sending it to Bluetooth (408 in FIG. 4) in the providers premise or to the server by using a MMS (406 in FIG. 4). In this case, the consumer has to select the Bluetooth target address manually.

In one embodiment where the consumer does not have camera in his mobile device, he can manually enter the Review Code displayed along with Barcode as an alphanumeric text and still be able to provide a review.

Communication channel represents the communication method in which the mobile phones connect to one another or to the Review Server for the purpose of registering the consume reviews. There are a variety of such channels available and new ones are being introduced frequently. The most popular types of communication channels are given below as non-limiting examples:
Bluetooth, wireless USB: This is a short range wireless communication method and will be used to transmit reviews from consumer's mobile phone to the providers mobile phone
SMS, MMS, E-mail: These are wide range wireless communication methods and will be used to transmit reviews from consumers mobile phone to the Review Server or providers mobile phone to the Review Server.

FIG. 5 is a block diagram that illustrates aspects of a review client 500, according to certain embodiments of the invention. A consumer launches the review client (400) to give a review. The review client obtains the users communication preferences (502). If the choice is to use Bluetooth in an automatic mode or SMS or HTTP, the review client obtains the target address of the Bluetooth device, SMS or HTTP by decoding the review code (504). If the choice is to use Bluetooth in manual mode or use MMS, the review client accepts the target address from the user. The review client checks to see if the review choices are present in the review code (508). If the review choices are not found, the review client obtains the review choices by connecting to the review server by using the connection method and target address set as described above. Once the review choices are obtained, the review client displays the choices to the consumer and accepts the responses from the consumer (512). The review client then constructs the review transaction and sends it to the review server (514). The review client then receives the reward transaction from the server (518) and displays it to the consumer (520) and to the provider, so that the provider can present the reward to the consumer.

According to certain embodiments, a review Client is a computer program embodied in at least one computer, which reads an electronic image of the Review Code and decodes the information embedded in the review code. For example, the embedded information may be ‘Service provider 12345’ or ‘I liked the service provided by service provider number 123456’. The review client itself can either be located in the mobile phone and/or at the Review Server

When the review client is located in the mobile phone of the consumer, the review client can decode the review code image or picture and present the review choices to the consumer in the natural interface of the mobile phone, in an interactive mode. The review client accepts interactive instructions from the consumer to create review transactions, employee performance review transaction, award transaction or Wait Transactions, for example.

FIG. 6 is a block diagram that illustrates aspects of a review server, according to certain embodiments of the invention. FIG. 6 shows review server 600, review net 102a, review net 102b, review net 102c, provider portal 632, consumer portal 634, which may be connected through internet/wireless connection. Review server 600 includes review database 602, review transaction processor 604, recommend transaction processor 606, reward transaction processor 608 and review analytics and search services 610. In certain embodiments, the review server can also include product registry & service call manager, queue, raffles & coupon manager, poll & survey manager and an authentication manager Not shown in FIG. 60.

Review Net 102a includes review code manager 300, review client 500a for user-A, review transaction 104, reward transaction 106, and review code 210. Review Net 102b includes review client 500b for user-B, review client 500a for user-A and recommend transaction 108. Review net 102b does not require a connection to the internet/wireless networks. Review net 102c includes review code manager 300, review client 500b for user-B, review transaction 104, reward transaction 106, and recommend transaction 108.

The Review Server is a computing system, which is connected to the Internet. The Review Server receives wireless messages from the mobile phones of the providers and consumers and stores them in a review database. The review server also has computer programs and processors to process the received data and send wireless messages to the mobile phones of the service providers and consumers. For example, the review transaction processor receives the review transactions and updates the feedback data in the review database. The reward transaction processor determines the rewards to be awarded to the consumers and created the reward transaction. The recommend transaction processor saves the recommendation data to the review database. The recommendation data may in turn be used by the reward transaction processor to offer rewards to consumers by creating the reward transactions. The review server also acts as an Internet site (or service) for users to connect and view and analyze the database for various purposes. The Review Analytics & Search services are a significant component of the review server.

Providers can use the Provider Search portal for Business Intelligence to gather information from the Analytics data in the Review Database. The Analytics data contains various summary and business intelligence information, including but not limited to the following:
number of consumers who liked the service or product
number of new consumers and the repeat consumers
number of consumers who recommended the products and service to others

Consumers can use the Consumer Search portal to search for products and services based on feedback from Social Networks. Consumers define and create their social networks as part of the consumer data in the Review Database.

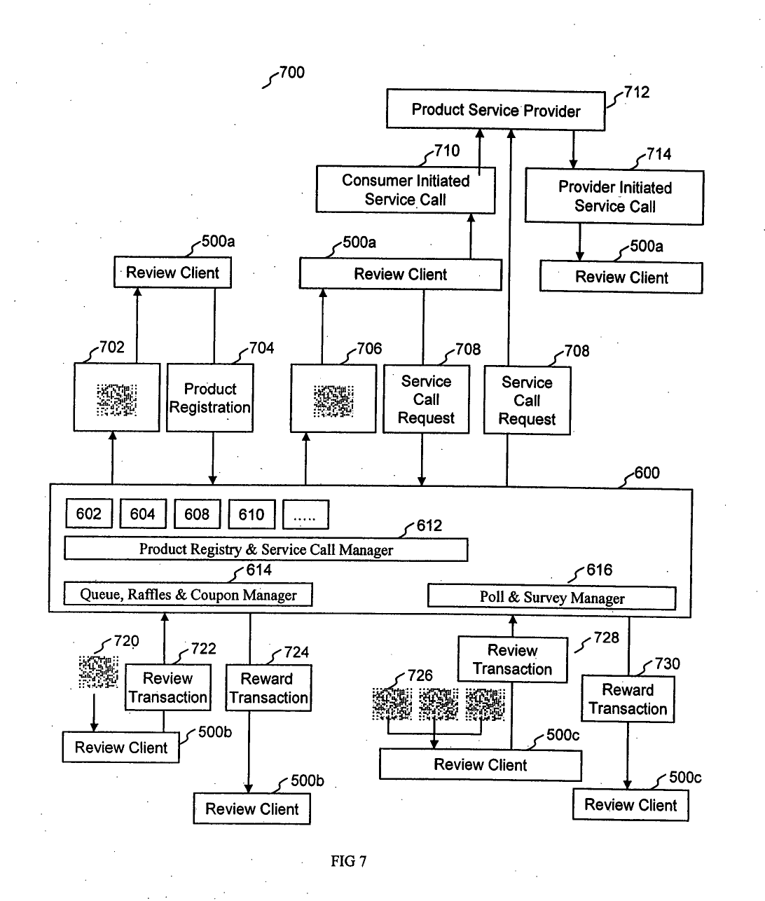

FIG. 7 is a block diagram that illustrates aspects of procedures by which a consumer can receive and manage promotional coupons, registration of products, initiating service calls, take part in promotional raffles and/or polls, according to certain embodiments of the invention. FIG. 7 shows review server 600, review client 500a, review client 500b, review client 500c, product registration code 702, review client 500, product registration 704, service call initiation code 706, service call request 708, consumer initiated service call 710, provider initiated service call 714, product service provider 712, review code 720, review transaction 722, reward transaction 724, polling review code 726, review transaction 728 and reward transaction 730. Review server 600 includes review database 602, review transaction processor 604, recommend transaction processor 606, reward transaction processor 608 and review analytics and search services 610, product registry & service call manager 612, queue, raffles & coupon manager 614 and poll & survey manager 616.

Use case scenario: Consumer participation in Raffles
A provider uses review codes (720) to represent raffles and includes them in his promotional and marketing materials, in various media such as news papers, magazines, bill boards, internet and television advertisements, for example. When a consumer sees the review code (720) and is interested in the participating in a raffle, the consumer captures the review code (720). The review client 500b then sends a review transaction (722) to the review server (600). The queue, raffles and coupon Manager (614) uses the consumer number in the review transaction to check if the consumer has won the raffle. It notifies the consumer by creating and sending a reward transaction (724).

Use case scenario: Consumer participation in Polls
A poll or survey (726) can also be represented in review codes. For example, one review code is used to represent each of the various choices in a poll. In case of a poll or survey, the consumer captures one of the review codes (726). The review client 500c then sends a review transaction (728) to the review server 600. In case of a poll or survey (728), the consumer number and the selection are used to register consumer's entry to the poll or survey. Poll results or associated rewards are sent to the consumer through a reward transaction (730).

Use case scenario: Queue Management
In instances where the number of consumers are more than the available capacity at the premises of the provider (for example, there are not enough tables in a restaurant), the consumers have to wait. The provider has to manage this queue of consumers and provide them service as soon as capacity becomes available. Currently, there are many ways this queue management problem is being handled. Some of them are
   Write down the name of the consumer and call their name when capacity is available. While this method is simple to execute, the consumer has to remain close to the service provider location which limits his mobility during the time of the wait.
   Hand the consumer a wireless device and use a short range wireless transmitter to inform the consumer when capacity is available. While this gives a limited amount of mobility, the consumer has to carry an often bulky device. The wireless device is also at a risk of being lost or stolen.
In the proposed review system, the consumer uses his mobile phone to register himself in the queue, by scanning the review code (720). The review client (500b) sends a wireless message to the queue, raffles and coupon manager (614) in the for of a wait transaction (722). The wait transaction includes the provider number and the consumer number and the time of entry. Upon receipt of the wait transaction, the review server (600) places the consumer in the queue for the provider.
When capacity is available, the provider will send a wireless message to the review server (600) regarding the availability. The queue, raffles and coupon manager (614) notifies the next available consumer in the queue so that he can proceed to the provider location to avail himself of the service. The review server (600) uses the SMS or mobile number associated with the consumer number (if he has opted for it) for the purpose of this notification.
The above method is simple and provides the consumer enough mobility. His privacy is also protected in this method since he does not have to provide his mobile number to the provider.

Use case scenario: Product Registration and Service Call Initiation
A provider at the time of selling a product attaches a review code (702), as a sticker, to represent the unique number for the product. The consumer uses his mobile phone to capture this review code (702). The review client (500a) then sends a product registration request (704) as review transaction to review server (600). The product registry and service call manager (612) updates the review database to indicate the scanned product is registered to the consumer, using the consumer number in the review transaction (704).
Once registered, the consumer can access information on the product such product manuals, warranty information, product service/repair history, product ownership history, by scanning or capturing the review code present in the product.
When the consumer encounters a problem with the product, he captures the review code (706) on the product using his mobile phone. The review client (500a) then sends a service call request (708) as a review transaction to the review server.
The product registry and service call manager uses the product number and the consumer number to retrieve the contact number of the service provider contracted for the product. A service call request message (708) is sent to the service provider (712), with the details of the service call and is placed in the queue of the customer service personnel. Depending upon the consumer preferences, one of the following can occur:
   The review client (500a) automatically initiates the service call to the service provider (710); or
   The service provider's communication network initiates the call to the customer (714), based on the pending request in their queue.
In either of the above cases, the customer service person who receives the call is able to assist the customer better, since the service call request message already has the required information associated with the service call.
The above mentioned approach can also be used for consumers requiring reporting problems and requesting service calls for products not owned by the consumer. Such examples are:
   Office employee at work can capture the review code on a broken copier and request a service call to fix the copier.
   Tenant in a housing complex can capture a review code on a broken washing machine to request a service call to fix the washing machine
   Visitor in a public park can capture the review code on a broken water fountain to request a service call to fix the water fountain.

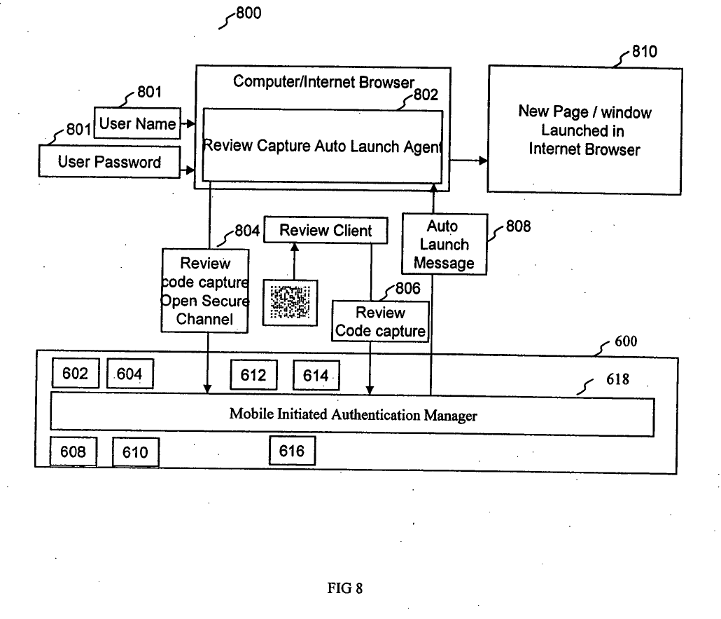

FIG. 8 is a block diagram that illustrates aspects of procedures for product registration and service call initiation, according to certain embodiments of the invention. FIG. 8 shows review server 600, user name and user password 801, review capture auto launch agent 802, new page/window launched in internet browser 810, review scan secure channel 804, review client 500, review scan 806, auto launch message 808. Review server 600 includes review database 602, review transaction processor 604, recommend transaction processor 606, reward transaction processor 608 and review analytics and search services 610, product registry & service call manager 612, queue, raffles & coupon manager 614 and poll & survey manager 616 and mobile initiated authentication manager 618.

Use case scenario: Review Capture Initiated Secure Internet Access
Currently, when consumers wish to access information on a product advertised on the Internet, they have to search for the product or call the product manufacturer or seller for information. But in cases where the consumer already has the product, with associated review code (such a sticker placed on the product at the time of purchase), the consumer can use his mobile phone to access information by scanning or capturing the image of the review code.
In the proposed system, the consumer first logs in to the review sever using his login and password (801). As a preference, the consumer can start the review capture auto launcher (802), a computer module running in the consumer's internet enabled computer or a plug-in in the internet browser session in any computer where the consumer is logged in.
The review capture auto launcher (802) when started with the user's credentials, connects to the mobile initiated authentication manager (618) and establishes a review capture secure channel (804).
After this, whenever the consumer captures a review code, the review client (500) sends a review capture message (806) to the mobile initiated authentication manager (618). Mobile initiated authentication manager (618) uses the information in the review capture message (806) to get the corresponding product information from the review database or website of the web server of the seller of the product and sends an auto launch message (808) to review capture auto launcher (802). Review capture auto launcher (802) then launches a new screen with the product information.

Use case scenario: Provider receives a Quick Review from a consumer
A provider, such as a restaurant or an auto body shop, puts up a display board on the premises of his business, requesting consumers to provide feedback through the consumers' mobile phones. The display board includes one or more of the review choices, displayed as review codes.
A consumer, who visits the service provider, will be able to use his mobile phone and provide a quick review, after he receives the product or service. To do this, the consumer takes a picture of the review code of his choice. This review client located in the consumer's mobile phone constructs the review transaction and sends it to the review server through the review net.
The review transaction processor receives the review transaction and stores it in the review database, for future processing and analysis.
The above scenario can also be performed while a provider visits the consumer's premises (plumber visits consumer's home to fix a leak) or any location (example, a stalled car being towed on a road side).
The above scenario can also be performed by the consumer using his review client application. The review client application asks for the review choices to be passed electronically, instead of taking the picture of the review codes.
The above scenario can also be performed by the consumer taking a picture of the review code using the standard camera application and sending captured review code to the review server, without installing the review client located in the consumer's mobile phone.

Use case scenario: Provider offers instant rewards to a consumer for customer loyalty.
Consumer uses his camera phone to give a quick review and this review transaction is sent to the review server.
The reward transaction processor uses this review transaction and the previous review transactions from the same consumer to determine the number of visits the consumer has made to this provider. The reward transaction processor then sends a reward transaction as a wireless message to the provider and the consumer, with the visit details.
The provider offers special discounts to the consumer for events, such as first time visit, repeat visits, or special raffle programs.
The above scenario can also be performed while a provider visits the consumer's premise (plumber visits home to fix a leak) or any location (a stalled car being towed on a road side).

Use case scenario: Consumer recommends a provider to another consumer, a friend or a family member.
A consumer (user-A) visits a restaurant (provider-S) and provides a quick review using consumer's mobile phone. For example, the consumer indicates that he liked the service. This review transaction is sent to the review server and also stored in the consumer's mobile device in an electronic format.
Later, user-A meets a friend, another consumer (user-B) and tells user-B that he liked the service in this specific restaurant (provider-S). In addition user-A opens his review client application in his mobile phone, chooses the service provider from the list of reviews that user-A provided earlier and clicks to send to his friend user-B. The review client forms a review net to the mobile device of the friend and transmits the recommendation transaction, and is now also stored in the mobile device of user-B in an electronic format.
Later the friend (user-B) visits the same restaurant (provider-s) and after receiving the product or service, gives a quick review.
The review transaction from the user-B is sent to the review server. In addition, the recommendation transaction is also sent to the review server. The review server uses the recommendation transaction and credits the consumers account for his number of promotions. User-B may also be eligible to get a reward transaction, for being a new customer for the provider.
Next time, when the consumer (user-A) visits the restaurant and submits a review, the review server will send a note to the provider about the recommendation he made to his friend user-B. The provider gives an award to the user-A for promoting his business to his friend user-B.

Use case scenario: Provider is able to analyze and gather intelligence on the feedback from his consumers to improve the product or service.
The provider will be able to connect to the review server's internet site and view the business intelligence information on the review transactions submitted by the consumers for any given period of time, such as
   the number of consumers who liked the service or product
   the number of new consumers and the number of repeat consumers
   the number of consumers who recommended the products and service to others
The provider will only be able to see the aggregate information but not any consumer specific information, in order to preserve the privacy of the consumers.

Use case scenario: Consumer is able to search for products and services based on the reviews submitted by himself and his social network.
The consumer will be able to use the internet site to connect to the Review Server and look for the reviews he has provided.
Using this internet site, he can also share his reviews with his friends and family or even to the general public, if he so desires.
Using the site, he will be able to search for products and services from providers based on the reviews provided by general public.
Using the site he will be able to search for service providers solely based on the reviews provided by his friends and family. This type of search eliminates any fraudulent reviews and ensures the results can be trusted.

Use case scenario: Employee Performance Management
A provider displays review codes which include the employee number of the employees in his organization who provide service to consumers. For example, a Restaurant might have multiple wait staff and the Review code displayed in every table in the restaurant will have the corresponding employee number.
A consumer gives a review on the service at a given table by using the review client. An employee performance review transaction, which is a special form of review transaction, is sent to the review server by the review client.
The provider can connect to the review server using the internet service and obtain the employee performance reports for his employees, based on the employee performance review transactions given by the consumers. The provider can then use this information to reward the employee or provide additional training to improve the performance.
The above scenario can be performed when a plumbing technician from a plumbing company visits a consumer's home or when a tow truck driver from a tow truck company helps a car driver on a road side location.

We claim:

1. A method for providing services, the method comprising:
receiving an encoded review code;
processing the encoded review code for further performing at least one of a group consisting of:
updating review database associated with the encoded review code;
determining awards associated with the encoded review code; and
updating recommendation data associated with the encoded review code.

2. A method for providing services, the method comprising:
providing at least one encodable review code for use as a consumer interface to interact with the consumer associated with providing services to the consumer;
encoding the at least one encodable review code based on a review code type.

3. A method for providing services, the method comprising:
capturing an encoded review code by a client device;
sending the encoded review code to a review system wherein the review system performs at least on from a group consisting of:
updating review database associated with the encoded review code;
determining awards associated with the encoded review code; and
updating recommendation data associated with the encoded review code.

4. A system for providing services, the system comprising:
a review database;
a review code manage to dynamically configure encodable review code;
a review client to manage service transaction choices associated with at least one service transaction; and
at least one processor for processing respective encoded review code that is associated with the at least one service transaction.

5. The method claim 2, further comprising dynamically encoding the at least one encodable review code based on a review code type and based on information that is dynamically provided by a provider.

6. The method claim 2, further comprising providing to the provider a user interface and encoding application for encoding the at least one encodable review code.

7. The method of claim 2, wherein the at least one encodable is associated with any one from a group comprising:
a review transaction;
a recommend transaction;
a reward transaction;
an employee performance review transaction;
a wait queue transaction;
a product registration transaction;
a raffle participation transaction;
a survey participation transaction;
a coupon transaction; and
a service all transaction.

8. The method of claim 1, further comprising one or more from a group comprising:
managing service queues associated with the encoded review code;
processing registrations in a raffle;
managing coupons;
managing a poll or survey;
managing service calls; and
processing registration of products.

9. The method of claim 3, further comprising one or more from a group comprising:
managing service queues associated with the encoded review code;
processing registrations in a raffle;
managing coupons;
managing a poll or survey;
managing service calls; and
processing registration of products.
